(19) United States
(12) Patent Application Publication
(10) Pub. No.: US 2009/0164888 A1
(43) Pub. Date: Jun. 25, 2009

(54) Automated Content-Based Adjustment of Formatting and Application Behavior

(76) Inventor: Thomas Phan, San Jose, CA (US)

Correspondence Address: STATTLER - SUH PC, 60 SOUTH MARKET STREET, SUITE 480, SAN JOSE, CA, 95113, US

(21) Appl. No.: 11/960,483

(22) Filed: Dec. 19, 2007

(51) Int. Cl. G06F 17/21; G06F 17/30; G06F 15/16

(52) U.S. Cl. 715/248; 707/103 R; 709/203; 707/E17.005

(57) ABSTRACT

Systems, including clients and servers, and methods relate to dynamically formatting content in a style based in part on the content. In particular, content generated by one user or group of users and presented over a communication medium is formatted based on features of the content. Embodiments relating to web, email and messaging content are described.

### BACKGROUND OF THE INVENTION

1. Field of the Invention

The present invention relates to methods of and systems for presenting user-generated content over communication media.

2. Art Background

Web pages and various communications applications are intended to convey content to readers. For example, news articles and weblogs on the Internet primarily provide their readers with text information or content amenable to text-based descriptive tagging. Similarly, applications such as instant messenger (IM) clients allow people to send text messages to one another. In either case, the text and other content is displayed with style attributes, such as the background or trim colors, adjoining images, and other visual traits, consistent with default settings, or settings manually adjustable by viewers or authors.

Existing communications interfaces provide means for changing formatting attributes that require manual intervention. Web page style attributes are manually set by the author through either changing the attributes of each HTML element or by setting CSS attributes. Web pages produced using free and ad-supported web authoring tools typically employ style and color schemes chosen by the corporation that owns the web page. Instant messenger clients allow users to set the style attributes through the application's user interface preferences to change colors or themes.

All major Internet advertising companies, such as Yahoo!, Google, or Microsoft, perform some form of content-matching on web page body text to delivery relevant ads to the end user. Such systems dynamically choose ads but do not set style attributes for page content.

### SUMMARY OF THE INVENTION

In one aspect, some embodiments of the present invention relate to computer-based methods. Consistent with this embodiment is a computer-implemented method of formatting an object based on features of the object. The method comprises steps of extracting content from the object and features from the object, analyzing the features to map the content to an emotion category. Further steps map the emotion category to a formatting attribute value and integrating the formatting attribute value into the object.

In further aspects, embodiments of the present invention relate to computer-implemented systems that dynamically format content in a style based in part on the content.

For example, a computer-implemented system for formatting content of an object based on features of the content is consistent with some embodiments of the present invention. Such a system comprises a content-extraction module that receives an object and extracts content from the object, a content-analysis module that uses features of the content to form a set of formatting instructions for the object, and a delivery module that receives both the object and the formatting instructions and presents the content by using the formatting instructions.

Some embodiments of the present invention relate to component portions of content-based formatting systems. For example, some embodiments relate to computer-based clients. Consistent with this aspect, a client is configured for presenting content received over a communication link. The client comprises a content-analysis module that uses features of the content to form a set of formatting instructions, and a delivery module that receives both the content and the formatting instructions and presents the content by using the formatting instructions.

Some embodiments relate to computer-based servers. Consistent with this aspect, a server is configured to provide an object that includes both content and formatting instructions based on the content over the web. The server comprises a content-analysis module that uses features of the content to form a set of formatting instructions for the content, and delivery module that combines both the content and the formatting instructions into the object and provides the object over the web to a client.

### BRIEF DESCRIPTION OF THE DRAWINGS

FIG. 1 is a conceptual diagram of a system for formatting content of an object based on features of the content consistent with some embodiments of the present invention.

FIG. 2 is a block diagram illustrating a more-detailed system for formatting content of an object based on features of the content consistent with some embodiments of the present invention.

FIG. 3A illustrates a messaging client graphical user interface.

FIG. 3B illustrates a messaging client graphical user interface with highlighting and labeling of aspects operated on by content-based formatting elements consistent with some embodiments of the present invention.

FIG. 3C illustrates a messaging client graphical user interface incorporating content-based formatting consistent with some embodiments of the present invention.

FIG. 4A illustrates a presentation page of a weblog.

FIG. 4B illustrates a presentation page of a weblog with highlighting and labeling of aspects operated on by content-based formatting elements consistent with some embodiments of the present invention.

FIG. 4C illustrates a presentation page of a weblog incorporating content-based formatting consistent with some embodiments of the present invention.

### DETAILED DESCRIPTION

This disclosure sets forth methods and systems related to the formatting of content based on features of the content. Embodiments address several challenges: (1) identifying concepts in the content, (2) using these concepts to change formatting attributes, and (3) integrating the formatting attributes and content for presentation to a user.

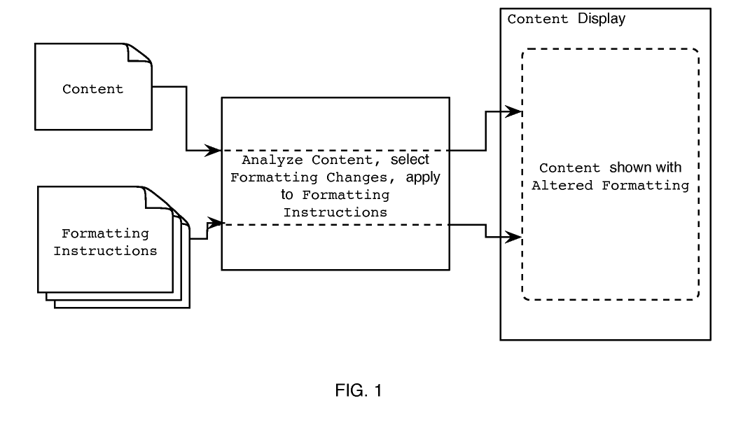

FIG. 1 illustrates a system for formatting content of an object based on features of the content consistent with some embodiments of the present invention. The system receives Content and Formatting Instructions, and displays Content using a set of Altered Formatting Instructions generated from the Content. An Analysis module of the system analyzes the Content, selects Formatting Changes based on the analysis, and integrates the Formatting Changes with the Formatting Instructions to form the Altered Formatting Instructions. A Content Display module of the system displays the Content, optionally including Supplemental Content, using the Altered Formatting Instructions.

Various embodiments consistent with the present invention operate on a variety of content types and formatting instructions. For example, some embodiments of the invention analyze body text within an HTML document to generate style attribute alterations for an associated CSS document. Some embodiments analyze email text to generate alterations for user-interface elements within an email client based. Some embodiments analyze text from a real-time messaging session to generate alterations for user-interface elements of a messaging client.

In addition, embodiments of the present invention contemplate a variety of content analysis methods. For example, some embodiments that perform textual analysis attempt to match the body of text to an existing inventory of known keywords, phrases, or patterns. Exemplary matching criteria include word frequency and regular expression matching.

Operational Details

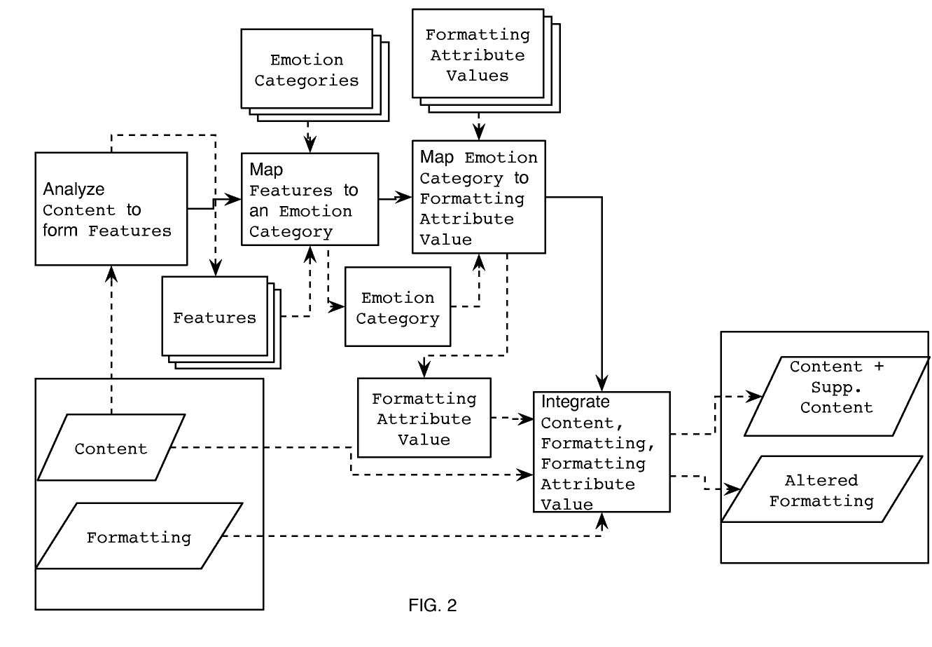

FIG. 2 is a block diagram illustrating a system of formatting content of an input object based on features of the content consistent with some embodiments of the present invention. The system operates on an object that comprises Content and Formatting, using a multi-step process to alter the Formatting based on the Content.

First, the system analyzes the Content to form a set of Features. Then, the system maps the set Features to an Emotion Category selected from a set of possible Emotion Categories. Following that, the system maps the Emotion Category to a Formatting Attribute Value selected from a set of possible Formatting Attribute Values. The system produces Altered Formatting by Integrating Content, Formatting and the Formatting Attribute Value. In some embodiments a system inserts Supplemental Content in addition to the original Content and the Altered Formatting. Preferably the Altered Formatting and the Content (optionally including the Supplemental Content) are integrated into an output object.

In some embodiments a system consistent with the present invention operates on HTML documents. A typical HTML document includes content information, such as text, images, and metadata, and formatting information, such as style tags. Often, HTML documents include references to external formatting information or documents, such as Cascading Style Sheet (CSS) documents.

In one example a system consistent with FIG. 2 operates on an HTML document. Initially, the system extracts Content from the HTML. After analyzing the Content to form a set of Features, the system maps Content Features to an Emotion Category. In HTML, extracted Content preferably includes body text and exemplary mapping strategies include matching words or phrases within the body text to predefined keywords or keyphrases. Extracted Content might also include text tags for images, or metadata, for which keyword-based strategies also apply.

The Emotion Category is then mapped to a Formatting Attribute Value. For HTML exemplary Formatting Attribute Values preferably relate to CSS style attributes. However, some embodiments include Formatting Attribute Values that relate to non-CSS HTML tag values. Preferably Emotion Categories are correlated with defined sets of Formatting Attribute Values, but for a given document the specific Formatting Attribute Values selected depends on the Content or Formatting of that document.

Finally, the system integrates the Formatting Attribute Values, the Content and the Formatting to produce an output document comprising Altered Formatting and Content. In some embodiments the output includes Supplemental Content but in some embodiments the output includes only the original Content.

In some embodiments a system consistent with the present invention operates on data streams, for example real-time data produced by a messaging session. A typical messaging data stream includes content information, such as text and metadata. Sometimes messaging data streams include formatting information, such as font or color instructions. More typically the messaging client receiving a messaging data stream determines how to format the data based on user preferences or permanent user-interface settings.

In one example a system consistent with FIG. 2 operates on a messaging data stream. Initially, the system extracts Content from the stream. After analyzing the Content to form a set of Features, the system maps the Features to an Emotion Category. In a data stream, extracted Content preferably includes message text and exemplary mapping strategies include matching words or phrases within the text to predefined keywords or keyphrases.

The Emotion Category is then mapped to a Formatting Attribute Value. For messaging, exemplary Formatting Attribute Values preferably relate to UI display attributes. Preferably Emotion Categories are correlated with defined sets of Formatting Attribute Values, but for a given document the specific Formatting Attribute Values selected depends on the Content or Formatting of that document.

Finally, the system integrates the Formatting Attribute Values, the Content and the Formatting to produce an output document comprising Altered Formatting and Content. In some embodiments the output includes Supplemental Content but in some embodiments the output includes only the original Content.

In some embodiments a system consistent with the present invention operates on email documents. A typical email document includes content information, such as text, subject, and attachments. Increasingly, email documents contain formatting information, such as HTML-based formatting. Usually the email client determines how to format the email based on user preferences or permanent user-interface settings, in combination with any formatting data present.

In one example a system consistent with FIG. 2 operates on an email document. Initially, the system extracts Content from the document. After analyzing the Content to form a set of Features, the system maps Content Features to an Emotion Category. In an email, extracted Content preferably includes message text and subject and exemplary mapping strategies include matching words or phrases within the text to predefined keywords or keyphrases.

The Emotion Category is then mapped to a Formatting Attribute Value. For email exemplary Formatting Attribute Values preferably relate to at least one of UI display attributes and HTML-based formatting information. Preferably Emotion Categories are correlated with defined sets of Formatting Attribute Values, but for a given document the specific Formatting Attribute Values selected depends on the Content or Formatting of that document.

Finally, the system integrates the Formatting Attribute Values, the Content and the Formatting to produce an output document comprising Altered Formatting and Content. In some embodiments the output includes Supplemental Content but in some embodiments the output includes only the original Content.

### EXAMPLES

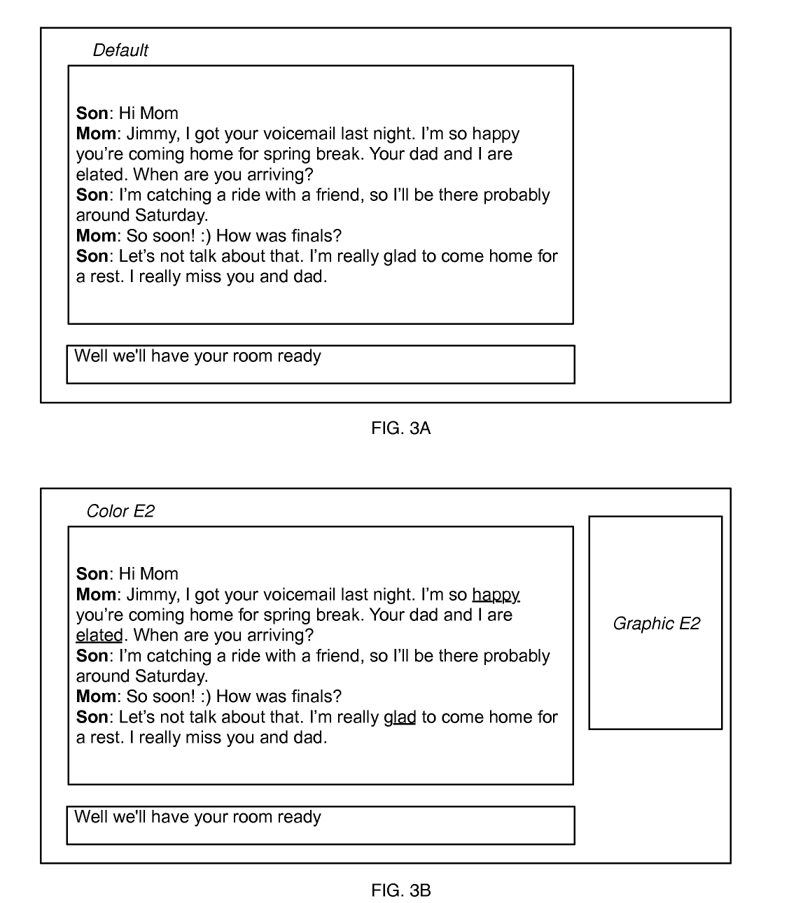

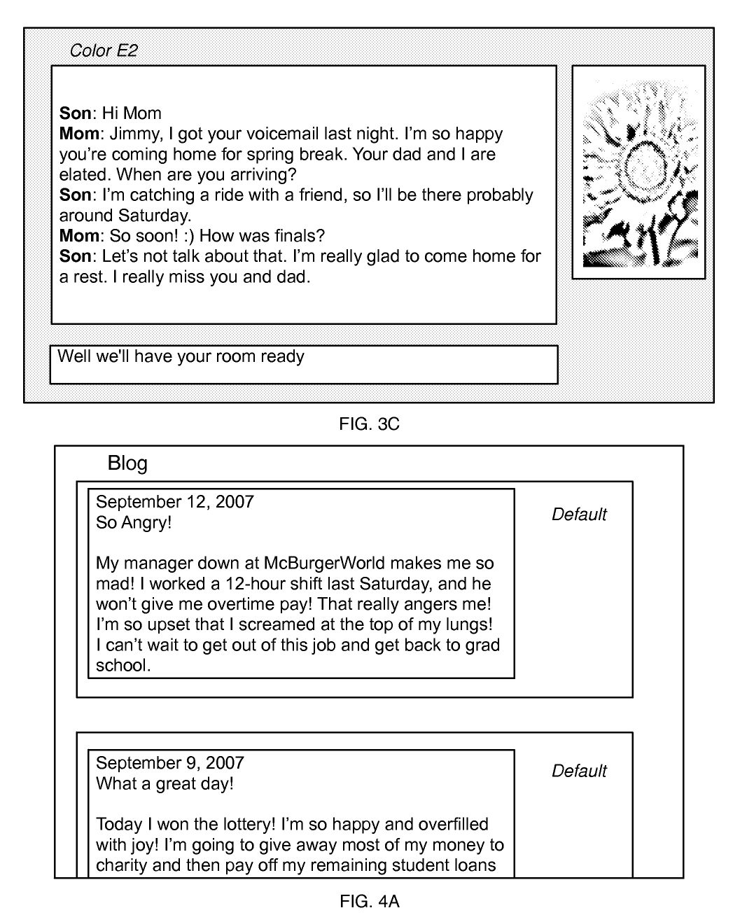

FIGS. 3A, 3B and 3C illustrate messaging client user interfaces. FIG. 3A illustrates a traditional messaging client. FIG. 3B illustrates aspects of the traditional user-interface and content operated on by some embodiments of the present invention. FIG. 3C illustrates a messaging client displaying content in a manner consistent with the present invention.

As shown in FIG. 3A, a messaging client displays a messaging history in a main panel and provides a message entry box adjacent to a submit control to continue the messaging session. The formatting with which the messaging history and the client in general are displayed is consistent with user preferences and user-interface settings of the client. In FIG. 3A the general client and messaging history both employ a default formatting theme.

FIG. 3B illustrates a messaging client displaying a messaging session identical to that of FIG. 3A. FIG. 3B illustrates how a system consistent with the present invention extracts words from the messaging session based on keywords and changes the UI formatting based on those extracted words. The words extracted as features in this exemplary session are underlined in the messaging history panel. Based on these features, the system identifies an Emotion Category for the session, or for the most recent portion of the session. For example, the system associates the underlined words with Emotion E2 and selected an appropriate color scheme, here involving Color E2, and accompanying image, Graphic E2. In this instance, the system supplements the messaging content with additional graphical content. Preferably systems consistent with the present invention associate colors and graphics with emotion categories based on known mood-color or mood-graphic associations. For example, in FIG. 3B the underlined words represent a happy mood. Hence, one choice for Color E2 is a light-sky blue, which is known to be calming and relaxing. Similarly, a calm or happy graphic, such as a flower or frolicking puppy, would be chosen for Graphic E2.

FIG. 3C illustrates a messaging client displaying a messaging session identical to that of FIG. 3A but in a manner consistent with the present invention and formatted based on features extracted as in FIG. 3B. In FIG. 3C Color E2 is used for the background and the accompanying image, Graphic E2, is displayed. Note that the graphic chosen is a flower, a symbol conventionally associated with calmness or happiness.

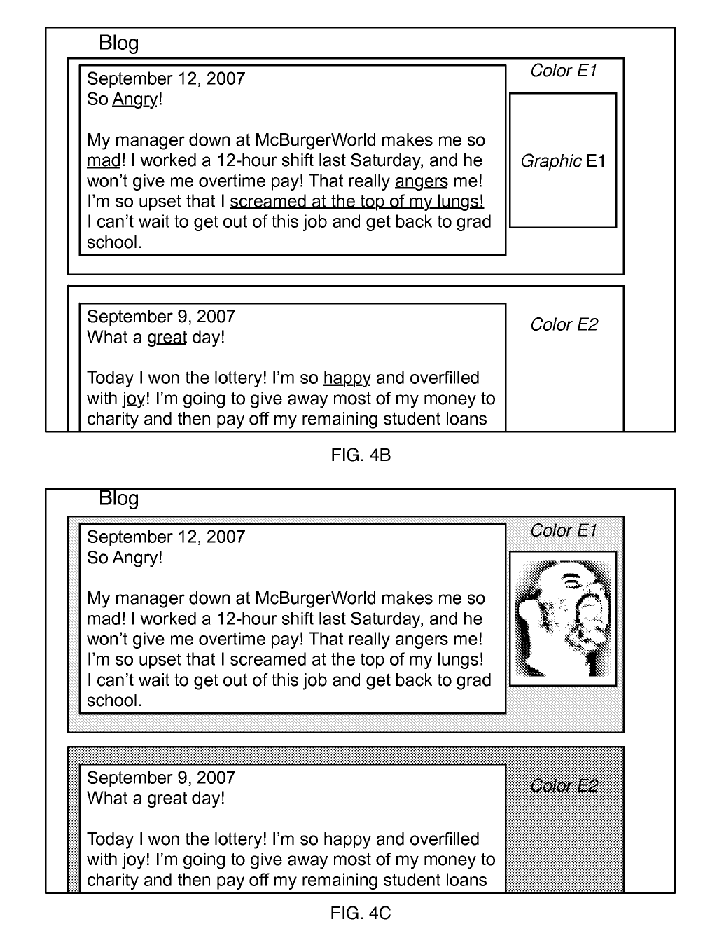

FIGS. 4A, 4B and 4C illustrate weblog presentation interfaces. FIG. 4A illustrates a traditional weblog with uniform formatting. FIG. 4B illustrates aspects of the traditional user-interface and content operated on by some embodiments of the present invention. FIG. 4C illustrates a weblog that displays content in a manner consistent with the present invention.

As shown in FIG. 4A, a weblog includes a main panel and displays a series of post within sub-panels. The formatting with which the main panel and the sub-panels are displayed is consistent with weblog settings (selected by the author), weblog defaults (determined by the weblog authoring tool), and browser settings. In FIG. 4A the weblog employs a default formatting theme.

FIG. 4B illustrates a weblog displaying content identical to that of FIG. 4A. FIG. 4B illustrates how a system consistent with the present invention extracts words from the weblog based on keywords and changes the weblog formatting based on those extracted words. The displayed portion of the weblog includes two posts, each displayed in a different subpanel. FIG. 4B a system consistent with the present invention extracts words and phrases from the weblog content based on keywords and keyphrases. The words and phrases extracted as features in each post are underlined. Based on these features, the system identifies an Emotion Category for each post.

For the first post, the system associates the underlined words with Emotion E1 and selected an appropriate color scheme, here involving Color E1, and accompanying image, Graphic E1. In this instance, the system supplements the weblog content with additional graphical content. For the second post, the system associates the underlined words with Emotion E2 and selects an appropriate color scheme, here involving Color E2.

Preferably the system associates colors and graphics with emotion categories based on known mood-color or mood-graphic associations. For example, in the first post of FIG. 4B the underlined words and phrases represent an angry mood. Hence, one choice for Color E1 is red, which is known to be associated with passion or anger. Similarly, an angry graphic, maybe a mad face or a storm cloud, would be an appropriate choice for Graphic E1, given of the angry mood detected in the post. The second post of FIG. 4B includes underlined words and phrases represent a happy mood. Hence, one choice for Color E2 is a light-sky blue, which is known to be relaxing.

FIG. 4C illustrates a weblog displaying content identical to that of FIG. 4A but in a manner consistent with the present invention and formatted based on features extracted as shown in FIG. 4B. The displayed portion of the weblog includes two posts, each displayed in a different subpanel. The first post, the system uses a color scheme based on Color E1, and accompanying image, Graphic E1. As shown, Graphic E1 is a sad and angry child. In this instance, the system has supplemented the weblog content with additional graphical content. For the second post, the system has used a color scheme based on Color E2.

Advantages

Websites or applications implementing embodiments of the present invention yield improved user experience and an increased likelihood of the user staying on a webpage network or messaging system, allowing the network owner to display more advertisements or otherwise further monetize the time spent by the user on the network.

Web pages, messaging clients and other communications applications often relay information through content that includes text and other content amenable to tagging with descriptive text. For example, blogs, news articles, email, and text-based listings all use text as the means to convey information. Additionally, interactive applications such as IM clients allow users to send text-based messages to each another.

Content generated for interpersonal communication often elicits emotional responses in communicating parties. Formatting elements or additional content features with attributes complementary to the content-based emotional response can enhance that response. Attributes considered within embodiments of the present invention include the color of the background page or textbox, the color of trimmings surrounding the text or other user-interface widgets, and font face and size, and other thematic characteristics. Persons familiar with web interface design will recognize that these attributes can be captured in CSS; persons familiar with computer application user interface design will recognize that these attributes can be captured by graphical user interface widget parameters. In either case, consistent with embodiments of the present invention style attributes are used to emphasize or augment an emotional aspect of the content.

Although the present invention has been described in terms of specific exemplary embodiments, it will be appreciated that various modifications and alterations might be made by those skilled in the art without departing from the spirit and scope of the invention. The scope of the invention is not limited to the exemplary embodiments described and should be ascertained by inspecting the appended claims.

What is claimed is:

1. A computer-implemented method of formatting an object based on features of the object, comprising:
a. extracting content from the object and features from the object and the content;
b. analyzing the features to map the content to an emotion category;
c. mapping the emotion category to a formatting attribute value; and
d. integrating the formatting attribute value into the object.

2. The method of claim 1, further comprising delivering the object to an end user.

3. A computer-implemented system for formatting content of an object based on features of the content, comprising:
a. a content-extraction module that receives an object and extracts content from the object;
b. a content-analysis module that uses features of the content to form a set of formatting instructions for the object; and
c. a delivery module that receives both the object and the formatting instructions and presents the content by using the formatting instructions.

4. The computer-implemented system of claim 3 wherein the object is an HTML document and the formatting instructions are CSS instructions.

5. The computer-implemented system of claim 3 wherein the object is a data stream from a messaging session and the formatting instructions are user-interface widget parameters.

6. The computer-implemented system of claim 3 wherein the features of the content are keywords within text portions of the content.

7. The computer-implemented system of claim 3 wherein the features of the content are key phrases within text portions of the content.

8. The computer-implemented system of claims 6 or 7 wherein the text portions of the content include text tags of images within the content.

9. The computer-implemented system of claim 3 wherein the features of the content are used to classify the content into an emotion category and the set of formatting instructions is chosen based on the emotion category.

10. The computer-implemented system of claim 9 wherein the system provides supplementary content based on the emotion category to the delivery module.

11. A computer-based client for presenting content received over a communication link, comprising:
a. a content-analysis module that uses features of the content to form a set of formatting instructions; and
b. a presentation module that receives both the content and the formatting instructions and presents the content by using the formatting instructions.

12. The computer-based client of claim 11 wherein the content is part of an HTML document and the formatting instructions are CSS instructions.

13. The computer-based client of claim 11 wherein the content is part of a data stream from a messaging session and the formatting instructions are user-interface widget parameters.

14. The computer-based client of claim 11 wherein the features of the content are keywords within text portions of the content.

15. The computer-based client of claim 11 wherein the features of the content are key phrases within text portions of the content.

16. The computer-based client of claims 14 or 15 wherein the text portions of the content include text tags of images within the content.

17. The computer-based client of claim 11 wherein the features of the content are used to classify the content into an emotion category and the set of formatting instructions is chosen based on the emotion category.

18. The computer-based client of claim 17 wherein the client provides supplementary content based on the emotion category to the presentation module.

19. A server configured to provide an object that includes both content and formatting instructions based on the content over the web, comprising:
a. a content-analysis module that uses features of the content to form a set of formatting instructions for the content; and
b. a delivery module that combines both the content and the formatting instructions into the object and provides the object over the web to a client.

20. The server of claim 19 wherein the content is part of an HTML document and the formatting instructions are CSS instructions.

21. The server of claim 19 wherein the content is part of a data stream from a messaging session and the formatting instructions are user-interface widget parameters.

22. The server of claim 19 wherein the features of the content are keywords within text portions of the content.

23. The server of claim 17 wherein the features of the content are key phrases within text portions of the content.

24. The server of claims 22 or 23 wherein the text portions of the content include text tags of images within the content.

25. The server of claim 19 wherein the features of the content are used to classify the content into an emotion category and the set of formatting instructions is chosen based on the emotion category.

26. The server of claim 19 wherein the server provides supplementary content based on the emotion category to the delivery module.
